(19) United States
(12) Patent Application Publication
(10) Pub. No.: US 2010/0229399 A1
(43) Pub. Date: Sep. 16, 2010

(54) Fingertip Knife

(75) Inventors: Kenneth James Gleason, Verona, WI (US); Eric J. Williams, Verona, WI (US); Greg Falendysz, Sun Prairie, WI (US)

Correspondence Address: FOLEY & LARDNER LLP, 321 NORTH CLARK STREET, SUITE 2800, CHICAGO, IL, 60654-5313, US

(73) Assignee: Fiskars Brands, Inc.

(21) Appl. No.: 12/721,883

(22) Filed: Mar. 11, 2010

Related U.S. Application Data
(60) Provisional application No. 61/159,716, filed on Mar. 12, 2009.

(51) Int. Cl. B26B 5/00; B26B 27/00; B26B 1/08

(52) U.S. Cl. 30/162; 30/298; 30/335

(57) ABSTRACT

A cutting tool having a retractable blade and capable of being guided using a user's finger. The cutting tool comprises a handle portion having at a first end thereof a first elongated support member, a second elongated support member, and an open region therebetween. A second end of the handle portion is operatively connected to a first end of a sleeve portion. A second end of the sleeve portion has a blade exposing region. A blade carriage is slidably disposed within the sleeve portion and along a longitudinal axis thereof, and a blade is operatively connected to the blade carriage. The blade carriage can move between an extended position and a retracted position along the longitudinal axis of the sleeve portion. When the blade carriage is in the extended position, the blade extends outside of the sleeve portion adjacent the blade exposing region. When the blade carriage is in the retracted position, at least a portion of the blade carriage extends outside of the sleeve portion into the open region and the blade is positioned within the sleeve portion.

### CROSS-REFERENCE TO RELATED PATENT APPLICATIONS

This application claims priority to U.S. Provisional Application No. 61/159,716, filed Mar. 12, 2009. The contents of this application are incorporated herein by reference in their entirety.

### FIELD OF THE INVENTION

The present invention relates generally to cutting tools. More particularly, the present invention relates to small cutting tools capable of being guided by a user's finger (“fingertip knives”).

### BACKGROUND OF THE INVENTION

A number of fingertip knives are conventionally known. With these knives, a user controls the blade's movement across the cutting surface with his or her finger, typically the index finger. The position of the tip of the user's finger on the knife, in a position near the blade, allows for significant control of the blade during a cutting operation.

Although a number of fingertip knives are known, each includes certain limitations. In several conventional fingertip knives, the blade is not capable of being retracted when the knife is not in use. Such conventional knives therefore pose a potential risk of injury to the user because the blade is exposed both during and after the knife's use.

Some fingertip knives include a protective cover for shielding the user from the blade when the knife is not in use. However, such knives are often inconvenient, as they require users to remove the cover before using the knife and then replace the cover after use. Also, because the cover is separate from the knife, the cover can be easily lost after removal from the knife, or it could be inadvertently removed from the knife. If the cover is lost, the blade will remain exposed, thereby posing a danger to the user.

Other fingertip knives have attempted to address the situation by providing a retractable blade. When the knife is not in use, the blade can be retracted into the knife body, eliminating the danger of an exposed blade. When the knife is to be used, the blade can be deployed by the user. These knives, however, typically have worse performance when compared to the traditional fingertip knife. In particular, such retractable fingertip knives are significantly longer than the traditional fingertip knife in order to accommodate the retractable blade. Accordingly, in such knives, the fingertip of the user that is controlling the movement of the blade is significantly farther away from the blade and the cutting surface than in non-retractable fingertip knives. This leads to greater instability of the knife and thus less control of the blade by the user.

### SUMMARY

Various embodiments of the present invention comprise a cutting tool with a retractable blade. When the cutting tool is in use, the blade is deployed and the user can manipulate the cutting tool primarily with one finger. When the cutting tool is not in use, the blade can be retracted into a sleeve portion of the cutting tool in a manner that preserves the compact size of the cutting tool.

According to various embodiments, a cutting tool comprises a handle portion having at a first end thereof a first elongated support member, a second elongated support member, and an open region therebetween. A second end of the handle portion is operatively connected to a first end of a sleeve portion. A second end of the sleeve portion has a blade exposing region. A blade carriage is slidably disposed within the sleeve portion and along a longitudinal axis thereof, and a blade is operatively connected to the blade carriage. The blade carriage can move between an extended position and a retracted position along the longitudinal axis of the sleeve portion. When the blade carriage is in the extended position, the blade extends outside of the sleeve portion adjacent the blade exposing region. When the blade carriage is in the retracted position, at least a portion of the blade carriage extends outside of the sleeve portion into the open region and the blade is positioned within the sleeve portion.

These and other features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an exploded view of a cutting tool according to a particular embodiment;

FIG. 2 is a top plan view of the cutting tool of FIG. 1, showing the cutting tool in a retracted position;

FIG. 3 is a left side elevational view of the cutting tool in the position depicted in FIG. 2;

FIG. 4 is a front elevational view of the cutting tool in the position depicted in FIG. 2;

FIG. 5 is a bottom plan view of the cutting tool in the position depicted in FIG. 2;

FIG. 6 is a right side sectional view of the cutting tool along lines B-B indicated in FIG. 4;

FIG. 7 is a top plan view of the cutting tool of FIG. 1, showing the cutting tool in an extended position;

FIG. 8 is a left side elevational view of the cutting tool in the position depicted in FIG. 7;

FIG. 9 is a front sectional view of the cutting tool along lines D-D indicated in FIG. 8;

FIG. 10 is a front elevational view of the cutting tool in the position depicted in FIG. 7;

FIG. 11 is a right side sectional view of the cutting tool along lines C-C indicated in FIG. 10; and

FIG. 12 is a bottom plan view of the cutting tool in the position depicted in FIG. 7.

### DETAILED DESCRIPTION OF VARIOUS EMBODIMENTS

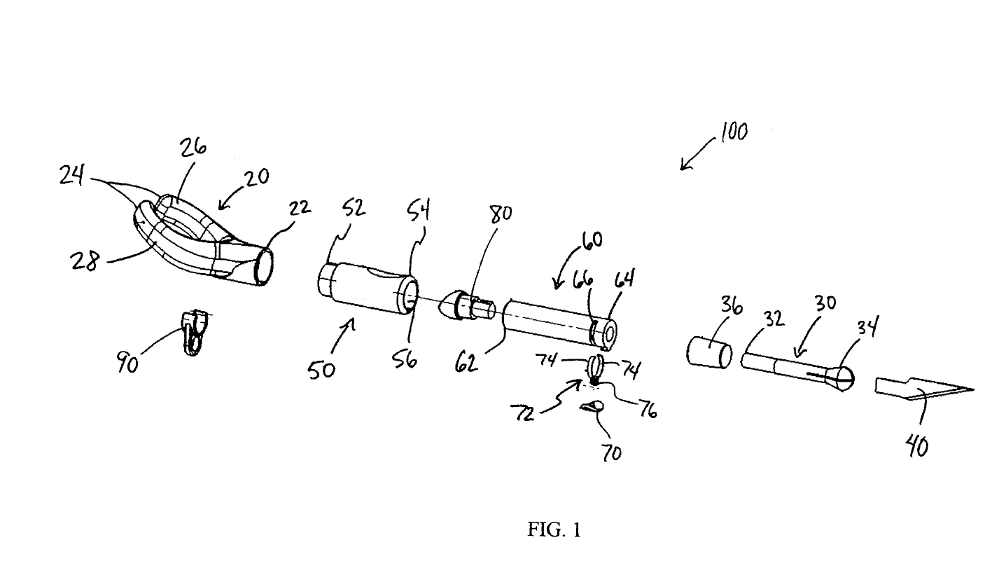

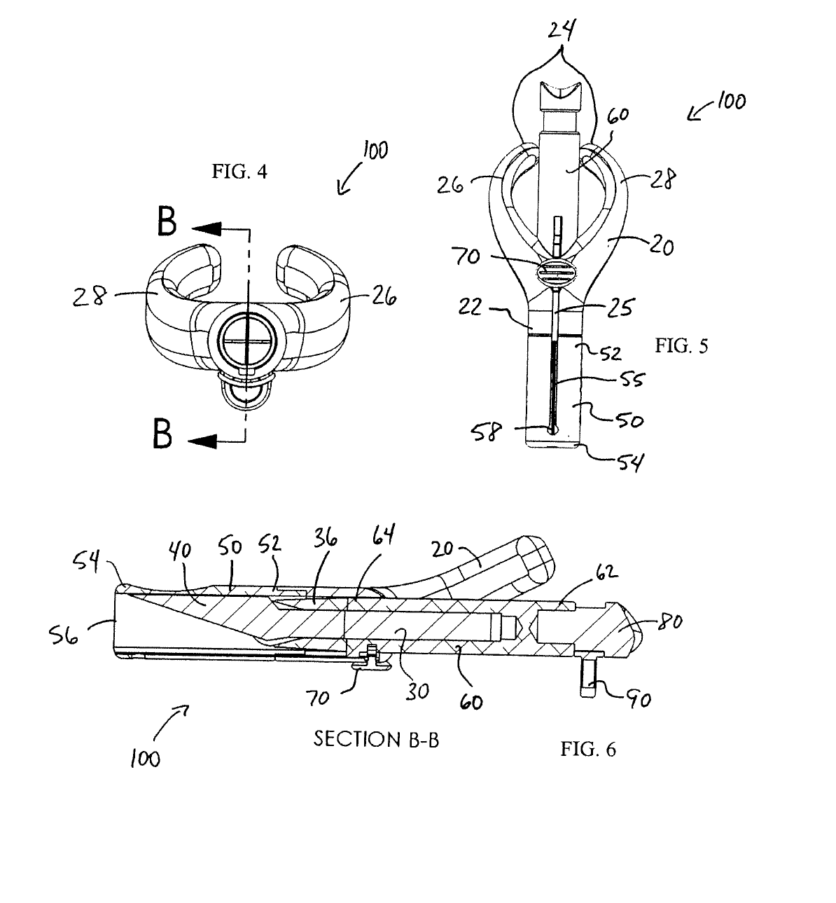

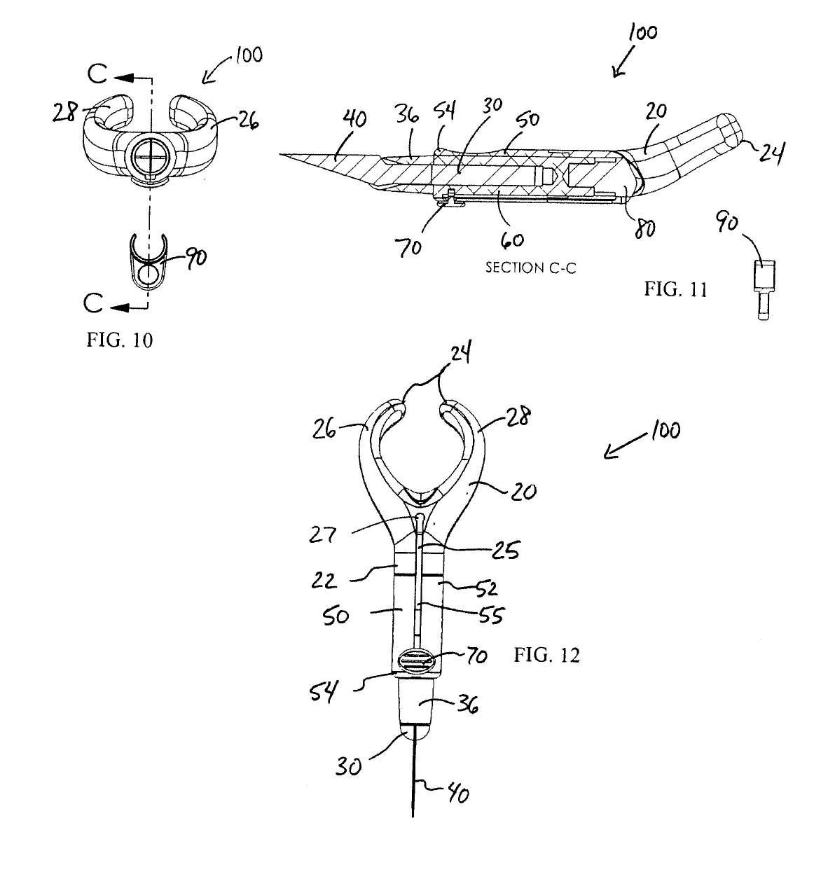

With reference to FIGS. 1-12, a cutting tool 100 constructed in accordance with an embodiment of the present invention is depicted. The cutting tool 100 comprises a handle portion 20 operatively connected at a second end 22 thereof to a first end 52 of a sleeve portion 50. A first end 24 of the handle portion 20 includes a first elongated support member 26 and a second elongated support member 28. The first and second elongated support members 26 and 28 support a user's hand when the cutting tool 100 is used, and the user's fingertip rests on the surface of the sleeve portion 50. A second end 54 of the sleeve portion 50 includes an opening 56 defining a blade exposing region.

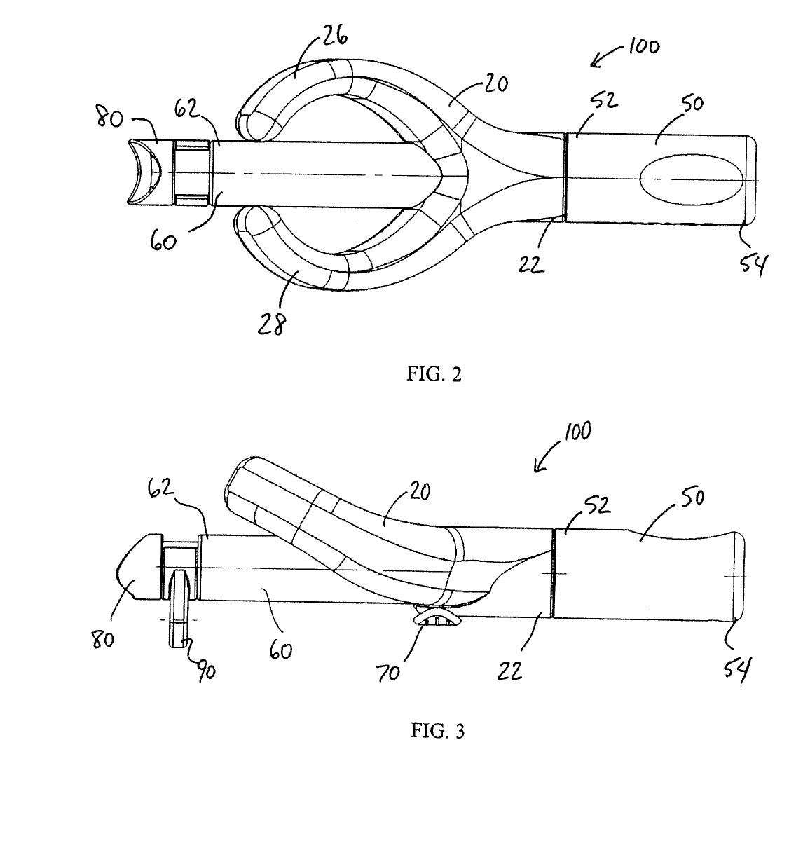

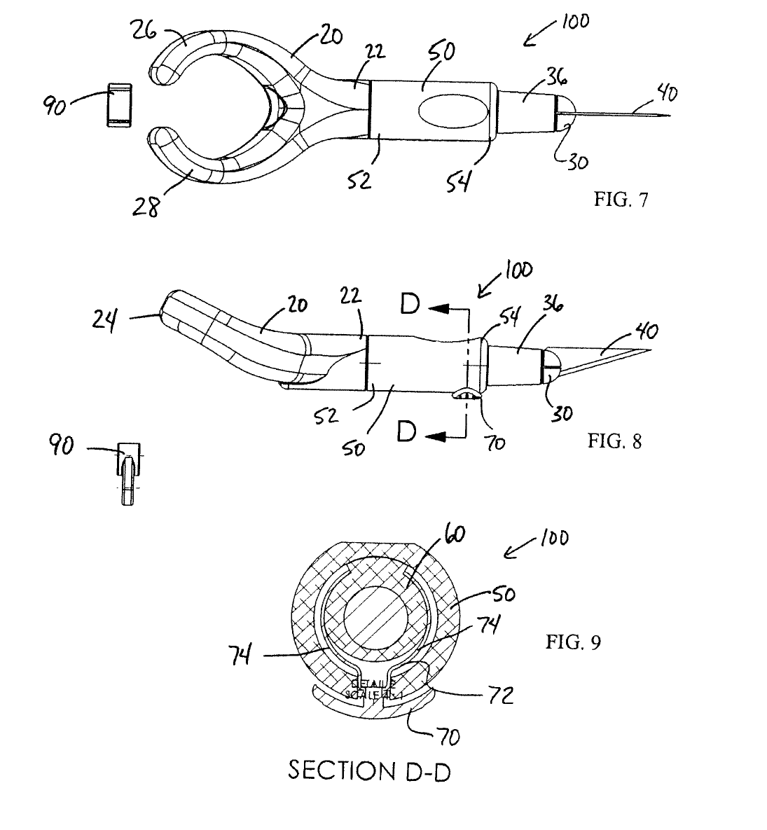

A blade carriage 60 is slidably disposed within the sleeve portion 50. The blade carriage 60 is movable along a longitudinal axis of the handle portion 20 and the sleeve portion 50 between a retracted position shown in FIGS. 2-6 and an extended position shown in FIGS. 7-12. A handle cap 80 may also be coupled to a second end 62 of the blade carriage 60.

As shown in FIG. 1, a first end 32 of a blade clamp 30 is operatively connected to a first end 64 of the blade carriage 60. A second end 34 of the blade clamp 30 is configured to selectively secure a blade 40. A lock collar 36 is slidably disposed around the blade clamp 30 and slidably disposed within the sleeve portion 50. The lock collar 36 interacts with the blade clamp 30 to retain the blade 40 in the cutting tool 100 when the lock collar 36 moves from a first position to a second position along the blade clamp 30.

With reference to FIGS. 5 and 12, the handle portion 20 has a first slot 25 that is aligned with a second slot 55 in the sleeve portion 50. The first slot 25 has a retracted position stop 27, shown in FIG. 12, and the second slot 55 has an extended position stop 58, shown in FIG. 5. Referring to FIG. 1, release band arms 74 of a release band 72 operatively interact with a groove 66 formed in the first end 64 of the blade carriage 60. A protrusion 76 of the release band 72 extends through the first slot 25 and the second slot 55, and a button cap 70 is coupled to the protrusion 76 of the release band 72 outside of the sleeve portion 50 and the handle portion 20.

The cutting tool 100 alternates between the retracted and extended positions when the button cap 70 is moved along the first and second slots 25 and 55 between the retracted position stop 27 and the extended position stop 58. Detents (not shown) can be utilized at the retracted position stop 27 and the extended position stop 58 to retain the button cap 70 and the release band 72 at these respective positions. In such a particular embodiment, the user applies a force to the button cap 70 sufficient to overcome the retaining force of the detents at the retracted position stop 27 and the extended position stop 58 to place the button cap 70 and the release band 72 in the first and second slots 25 and 55. Once the button cap 70 and the release band 72 are situated away from the detents, the button cap 70 can be moved along the first and second slots 25 and 55 to either extend or retract the blade 40.

To place the cutting tool 100 in the retracted position shown in FIGS. 2-6, the user moves the button cap 70 along the first and second slots 25 and 55 toward the retracted position stop 27 of the handle portion 20, as depicted in FIG. 5. The movement of the button cap 70 results in a corresponding movement of the blade carriage 60, the blade clamp 30, the lock collar 36, and the blade 40 along a longitudinal axis of the handle portion 20 and the sleeve portion 50 toward the first end 24 of the handle portion 20. When the cutting tool 100 is in the retracted position, the button cap 70 is situated at the retracted position stop 27, and at least a portion of the blade carriage 60 extends outside of the first end 24 of the handle portion 20, into an open region between the first elongated support member 26 and the second elongated support member 28. Also, and as shown in FIG. 6, when the cutting tool 100 is placed in the retracted position, the blade 40 is housed within the sleeve portion 50, thereby preventing a user from accidentally being cut by the blade 40. Furthermore, when the cutting tool 100 is in the retracted position, a lanyard clip 90 can be removably coupled to the handle cap 80 as shown in FIGS. 3 and 6.

To place the cutting tool 100 in the extended position shown in FIGS. 7-12, the user moves the button cap 70 along the first and second slots 25 and 55 toward the extended position stop 58 as depicted in FIG. 12. The movement of the button cap 70 results in a corresponding movement of the blade carriage 60, the blade clamp 30, the lock collar 36, and the blade 40 along a longitudinal axis of the handle portion 20 and the sleeve portion 50 toward the opening 56 of the second end 54 of the sleeve portion 50. When the cutting tool 100 is in the extended position, the button cap 70 is situated at the extended position stop 58, and the blade 40 extends outside of the second end 54 of the sleeve portion 50 adjacent the blade exposing region. Also, as seen in FIG. 11, most or all of the blade carriage 60 is housed within the handle portion 20 and the sleeve portion 50.

In another embodiment, the handle cap 80 can be operated by the user to move the blade carriage 60 between the retracted and extended positions. In such an embodiment, movement of the handle cap 80 results in a corresponding movement of the blade carriage 60, the blade clamp 30, and the blade 40 along the longitudinal axis of the sleeve portion 50 between the retracted and extended positions. Detents (not shown) corresponding to the retracted position and the extended position can be used to retain the blade carriage 60 in these respective positions in this embodiment. In such an embodiment, the user applies a force to the handle cap 80 sufficient to overcome the retaining force of the detents corresponding to the retracted and extended positions. Once the blade carriage 60 is situated away from the detents, the handle cap 80 can be moved along the longitudinal axis of the sleeve portion 50 to either extend or retract the blade 40.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of systems and methods.

What is claimed is:

1. A cutting tool, comprising:
a handle portion including a first end and a second end, the first end of the handle portion comprising a first elongated support member, a second elongated support member, and an open region therebetween, the open region exposed to a user;
a sleeve portion having a first end and a second end, the first end of the sleeve portion operatively connected to the second end of the handle portion;
a blade carriage slidably disposed within the sleeve portion and along a longitudinal axis thereof, the blade carriage slidable along the longitudinal axis between an extended position and a retracted position; and
a blade operatively connected to the blade carriage,
wherein the blade extends outside of the sleeve portion adjacent the blade exposing region when the blade carriage is in the extended position, and wherein at least a portion of the blade carriage extends outside of the sleeve portion into the open region and the blade is positioned within the sleeve portion when the blade carriage is in the retracted position.

2. The cutting tool of claim 1, further comprising a blade clamp operatively connected to a first end of the blade carriage, the blade clamp configured to selectively secure the blade to the blade carriage.

3. The cutting tool of claim 2, further comprising:
a lock collar slidably disposed around the blade clamp, wherein the lock collar interacts with the blade clamp to retain the blade when the lock collar moves from a first position to a second position.

4. The cutting tool of claim 1, further comprising a blade advancing assembly operatively connected to the blade carriage, wherein movement of the blade advancing assembly results in a corresponding movement of the blade carriage and a corresponding movement of the blade.

5. The cutting tool of claim 4, wherein the blade advancing assembly comprises:
a button cap located outside of the sleeve portion and the handle portion; and
a release band operatively connecting the button cap to the blade carriage,
wherein movement of the button cap along a first slot formed in the handle portion and a second slot formed in the sleeve portion results in a corresponding movement of the release band, thereby causing the blade carriage to move along the longitudinal axis of the sleeve portion between the retracted position and the extended position.

6. The cutting tool of claim 5, further comprising:
a first detent mechanism corresponding to the retracted position; and
a second detent mechanism corresponding to the extended position,
wherein the first detent mechanism retains the blade carriage in the retracted position and the second detent mechanism retains the blade carriage in the extended position.

7. The cutting tool of claim 1, further comprising a handle cap operatively connected to the blade carriage.

8. The cutting tool of claim 7, further comprising a lanyard clip configured to be removably coupled to the handle cap when the blade carriage is in the retracted position.
